(19) United States
(12) Patent Application Publication
(10) Pub. No.: US 2019/0330511 A1
(43) Pub. Date: Oct. 31, 2019

(54) Corrosion Preventing Composition Pump Additive for Cement and Method of Pumping Cement

(71) Applicant: Steven Glenn Shaw, Judson, TX (US)

(72) Inventor: Steven Glenn Shaw, Judson, TX (US)

(21) Appl. No.: 15/963,324

(22) Filed: Apr. 26, 2018

(51) Int. Cl. C09K 8/42; E21B 33/14; F04B 53/18

(52) U.S. Cl. CPC C09K 8/42; E21B 33/14; E21B 21/062; C09K 2208/28; F04B 53/18

(57) ABSTRACT

A concrete additive, which provides superior pump component protection, reduction of corrosion including wear and damage on pump components, and increased lifespan of the components in a concrete pump system. As concrete slurry mixes in the pump barrel of a ready mix cement truck, the concrete slurry blends directly with the pump additive and converges with the concrete pump components as the concrete blend mixes. This direct contact allows the pump additive to lubricate the component parts, which provides a corrosion inhibitor that protects the component parts from the harsh side effects of the aggregate rubbing against the liners, pistons and pump component parts thereby significantly extending the life of the component parts of the concrete pumping system. The cement additive compositions and methods of the present invention may be used in well bore drilling, cement production and delivery systems, and fracking operations.

### NOTICE OF COPYRIGHTS AND TRADE DRESS

A portion of the disclosure of this patent document contains material that is subject to copyright protection. This patent document may show and/or describe matter, which is or may become trade dress of the owner. The copyright and trade dress owner has no objection to the facsimile reproduction anyone of the patent disclosure as it appears in the Patent and Trademark Office patent files or records, but otherwise reserves all copyright and trade dress rights whatsoever.

### FIELD OF THE INVENTION

Embodiments of the current invention are related to the movement of cement broadly, and more particularly, to a novel cement composition additive that includes a lubricant admixed with cement slurry that provides protection to the storage environment, delivery lines, pump, and final destination in order to prolong the lifespan of component parts. The movement and delivery of cement slurry mixed with the pump additive mixture facilitates the movement of cement while simultaneously and significantly decreasing corrosion in the conduit, pump, and equipment in contact with the slurry mixture. This invention further relates to materials added to cement to adjust the properties or enhance and/or facilitate the use thereof.

### BACKGROUND OF THE INVENTION

The information in this section merely explain background information related to the present disclosure and may not necessarily constitute prior art.

Cementing is the most important and most expensive exercise during drilling operations. It is standard in the industry for cementing operations involving cement slurry to be prepared at one locality, loaded onto a truck or other convenient transportation means, and then moved to the location of its intended use. It is also typical that the cement slurry can be mixed and prepared for use while in motion during transport to the intended use locality. The transportation most frequently used to transport the cement slurry is a truck. This truck, well known in the art as a ready mix truck, prepares, mixes, and transports the cement slurry conveniently and efficiently.

Once the cement reaches the intended use locality, the cement slurry ideally will be ready to pour into place. The movement of cement is typically required to properly mix and prepare the cement slurry for the desired pouring time. Delays of any kind can be very costly to the cement contractor. While cement can be poured by the mere pull of gravity, most cement is poured with the help of pumps to pour the cement more efficiently. Pumps push the cement slurry from the mixing barrel of the ready mix truck through a conduit over a distance to the desired use location. The cement slurry must be moved through the mixing barrel and the conduit without delay once it reaches the desired location. Any unforeseen or significant delay could preclude the use of the cement slurry.

This cement compound could be made from different ingredients with different percentage of weight with respect to the weight of cement in the grout mixture (Labibzadeh et al. 2010). Compressive strength is one of the properties used to test the reliability of cementing and is the ability of a material to withstand deformation when load is applied. Compressive strength of a cement cement depends on the type of raw materials including additives used, mixture proportions, cement structure, method and time of curing, and exposure conditions (Herianto and Fathaddin 2005).

Cement systems for well cementing intend to withstand severe temperature and pressure situations. Cement additives modify the performance of cement slurry making it possible to accommodate a multiplicity of harsh environments. Additives improve the durability of the cement slurry to allow successful slurry placement in the desired location, rapid strength development, and resistance to corrosion. Cement additives are available in many different forms including solids and liquids. These cement additives may enhance compressive strength of the set concrete.

Cement will ideally develop high compressive strength in a minimum amount of setting time. The time required to develop compressive strength is dependent on temperature and the water to cement ratio. It is well known in the art that cement slurries with a high water content take a longer time to develop compressive strength than cement slurries with a lower water content ratio. Cement with a good compressive strength should be able to withstand hard and corrosive formations, lost circulation zone, carbon (IV) oxide and other toxic gas intrusion, and extremely high temperature (Benjamin et al. 2010).

Cement compositions generally have good durability and resistance to salts, acids, and other corrosive materials depending on the composition formulation. Because of this durability, the cement compositions are suitable for use in casings. In cementing operation, the annulus between the casing and the adjacent rock formation is filled with a certain compound of cement grout, which is allowed to set, usually after a few hours or a few days, and solidify strongly to join the casing to the formation.

Because cement with good compressive strength is ideal, cement additives are readily available to increase the compressive strength. Reducing the amount of water and using cement additives results in a higher density cement slurry, which also contains a higher paste quality. This increase in paste quality yields higher compressive and flexural strength, lower permeability, improves the cement bond strength, and numerous other desirable characteristics. However, the more paste like the cement slurry encompasses; the harder the cement slurry is to pump through the mixing barrel of the ready mix truck to the conduit. The increased energy required to pump the cement slurry deposits additional stress on the pumps and liners to move the cement slurry through the interior parts of the ready mix truck.

Cement slurry typically contains solids mixed in with the hydraulic cement that likewise increases the density of the composition. The dispersed solids contained in the cement mix usually consist of rock, sand, and graded fine aggregate, which can substantially damage the pump and interior mechanisms that come in contact directly with the cement slurry.

One way cement-pumping infrastructure is protected from pumps is utilizing a pump liner or sleeve as a surface area barrier to the component parts of the pumping mechanism. The liner acts as a protective layer to shield the actual pump and infrastructure from being in direct contact with the cement slurry. The liners and pistons themselves can also suffer tremendous corrosion from the abrasive surface of the cement slurry as it holds and transports the slurry. These liners are used to protect the pumps component parts from direct corrosion that likely will ensure failure of the overall system.

Protective surface coatings are widely used to provide the pumping structure a way to withstand the highly corrosive environment of the cement slurry. The cement is a very abrasive material since it also contains aggregate, and when the cement is pumped through the cylinders, sleeves, or liners, and pistons, it scars them pretty quickly. Once the liner is damaged and scared by the aggregate, the pump is not able to properly pump the cement or pump the cement all the way to its end location in the well bore.

Replacing the liners used to protect the pumps is more cost effective than replacing the pump itself. However, the liners are also expensive to replace and present a real issue for maintenance outlays of a cement pump system and delivery conduit. The cement slurry containing aggregate highly wears the liners and reduces the lifespan of sleeves, plungers, and seals to name a few examples. When the liners and component parts require replacing, the pump is out of service for the required maintenance shutting down the cement delivery system until the repair is complete. There is a real need for a corrosion solution to extend the lifespan of the liners and component parts of the cement pump system and protect the component parts from serious corrosion.

The typical intervals to replace the sleeves or liners, or removable piston cylinders located in the cement pumps mounted on the ready mix trucks averages anywhere between forty to eighty hours of pump operation. Average wear on the component parts equals replacement sleeves or liners every week to two weeks per pump. Parts and labor per sleeve or liner to replace the set at three sleeves per pump rapidly results in significant maintenance and repair costs.

It is well known in the art that cement slurry is difficult to pump through a conduit. The flow of pumping cement slurry is less than ideal without using some anticipatory measure that usually involves priming the pump and conduit. Prior art addressed this flow challenge by various methods including priming the conduit with a separate priming grout mix, a separate priming slurry mix, and a liquid mixture acting as a lubricant. All three of these methods require separate preliminary steps and mixtures that must be prepared and pumped through the pumps and conduit prior to mixing the actual cement slurry used in the desired location.

The methods of priming a cement slurry pump in the prior art all have similar disadvantages. While, the prior art priming compositions were somewhat effective in priming the pump component parts, liners, and conduit, they detrimentally require several additional time consuming and expensive steps. Because the admixture adversely affects the composition strength of the set cement, the priming grout mix and priming slurry mix cannot be admixed with the cement slurry. Since these priming compositions cannot mix with the cement slurry, the ready mix truck must prepare and mix the priming compositions prior to mixing the cement slurry.

Mixing the priming composition separately essentially doubles the mixing time of the concrete process because the priming composition is prepared and processed exactly how the concrete slurry mixture is prepared. The same mixing steps for the priming slurry must be repeated to prepare the end use concrete slurry. The pumps and conduit labor to prepare the priming composition and then the same pumps and conduit labor again to prepare the concrete slurry. This process strains the pumps and component parts as two mixture processes are necessary to achieve the proper priming of the concrete pumping system. Furthermore, this additional step wastes time in additional set up steps necessary to complete prior to mixing the desired cement slurry.

Once the priming mixture is ready to prime the conduit, the ready mix truck must be moved from the desired end use location of the cement slurry to a separate dumping area where the priming composition can be disposed. This creates an additional area needed on the jobsite as simply a waste disposal of the priming composition. Additionally, this waste disposal site could be a potentially hazardous environmental issue opening the door for potential liability for the concrete producer. Not only does it require additional space but that space invites the potential for legal issues. Once the priming mixture is disposed of entirely, the ready mix truck can then return to the desired end use location and the cement slurry can then be placed in the mixing barrel and prepared for use. Again, the same mixing steps must be repeated to prepare the cement slurry used in the pour.

Not only is the priming grout or priming slurry an extra step in the process, it also presents additional costs in raw materials plus the time it took to prepare, mix, and dispose of the priming mixtures. The priming grout mix typically consists of cement, water, and sand. The priming slurry typically consists of cement and water. Both of these priming methods require mixing a solid based composition that can be time consuming and difficult to mix properly. Other problems with mixing dry solids into a liquid form include the need to mix for an extended period of time, powder escaping into undesired locations during the mixing process, and the increased wear on the mixing equipment to mix and remix to the proper consistency. Furthermore, purchasing these priming materials simply to prime the cement slurry pump only to dump them out as waste is in fact wasteful.

There exists a significant need to develop a cement slurry that can be used to prime the cement slurry pump that does not adversely affect the composition strength of the set cement. Ideally, a cement slurry that primes the cement slurry pump while retaining optimal compressive strength would solve the problem of having to do a separate costly mix of wasteful priming cement or priming grout compositions.

A separate priming method set forth in U.S. Pat. No. 7,946,750, incorporate herein by reference, involves a priming agent that starts in liquid form. The liquid product is a slight improvement over the dry materials used in priming slurry and priming grout procedures. The water-soluble solution described is a liquid polymeric emulsion as a primer aid or lubricant coating for cement pump system and delivery conduit. The liquid based solution mixes substantially more efficiently than the dry powder in the priming grout and priming slurry in the initial priming step of the pump system.

The liquid priming aid generally acts as a lubricant and is biodegradable. This material is commonly referred to in the art as “aqueous gelling agents” and/or sometimes as “aqueous viscosifiers.” The prior art lubricant composition when mixed with water has a pH preferably in the range of from six to nine. The concentration of the lubricant composition mixed with water is a range from two to four ounces of lubricant composition to one hundred parts water.

The liquid composition mixes with the proper amount of water within the ready mix truck with ease and does not require a significant amount to time to prepare the useable primer. The liquid composition begins in the suction side of the cement pump and then is pressured by the ready mix truck pump into and through a conduit outside. While the mixture is being pressured into the conduit from the mixing barrel, before all of the mixture is pumped from the hopper, the end use cement slurry is added to the mixing barrel. A small portion of the liquid composition mixture comes in contact with the initial portion of the cement slurry where the mixture comes before the slurry through the pump and conduit outside the form. Again, the liquid composition can not be mixed directly with the cement slurry so this option remains an additional step prior to mixing the end use of the cement slurry.

While the liquid composition is an improvement over the wasteful, expensive, and time-consuming processes of priming slurry and priming grout, it still presents several subprime steps that slow the pumping process. Whereas the mixing step for the liquid composition is far superior to the powder mixing steps, it remains an additional step in the process required prior to pouring the cement slurry. The liquid must be mixed and pressured through the ready mix truck prior to the cement slurry. This additional step costs time and money to facilitate.

Additionally, similar to the priming grout and priming slurry, the liquid composition cannot be mixed with the cement slurry. A small initial portion of the cement slurry comes in contact with the final portion of the liquid composition but it cannot be mixed or used together as one composition. There remains a real problem to significantly improve the flow of cement through a cement pump system and delivery conduit in one combined priming and delivery process while protecting the inner components of the cement pump system including the liners, sleeves, and pumps that come in direct contact with the cement slurry.

### SUMMARY OF THE INVENTION

Embodiments of the current invention solve the need for a cement additive, which provides superior pump component protection, reduction of corrosion including wear and damage on pump components, and increases the lifespan of the components in a cement pump system.

It is an object of the current invention to provide a cement additive that reduces of cement pump system downtime due to fewer maintenance and repair needs.

It is a further object of the current invention to provide a cement additive that reduces wear on the entire cement pump system including liners and protective sleeves.

It is a further object of the current invention to provide a cement additive that improves cement pump performance and longevity.

It is a further object of the current invention to provide a cement additive that provides excellent cement pump protection and superior pump seal.

It is a further object of the current invention to provide a cement additive that significantly reduces the need to replace cement pump component parts by drastically improving the lifespan of the cement pump system components.

### BRIEF DESCRIPTION OF THE DRAWINGS

A complete understanding of the present invention may be obtained by reference to the acentitying drawings, when considered in conjunction with the subsequent, detailed description, in which:

FIG. 1 is a plot of hours of pump operation as a function of the percent of increased pump liner life according to an embodiment of the invention.

FIG. 2 shows a chart view of the results of an embodiment of the invention.

### DETAILED DESCRIPTION

The following detailed description is not intended to be understood in a limiting sense, but to be an example of the invention presented solely for illustration thereof.

The cement additive compositions and methods of the present invention may be used in well bore drilling, cement production and delivery systems, and fracking operations for example. The cement additive composition and methods of invention involve the use of the following components.

Cement pump additive is a fully synthetic additive involving monoethanolamine, triethanolamine and Monbutyl ether. The present invention is a blue water soluble liquid with a pH of 10.1. When the additive is diluted, the pH may be in the range of 10.1 to 9.5. The odor associated with the additive is bland. The additive is stable and room temperature in closed containers under normal storage and handling conditions. The composition comprises Monoethanolamine as 1-10 percent based on the total weight of the composition. The compositions comprises Triethanolamine as 1-10 percent based on the total weight of the composition. The composition comprises Monbutyl ether as 1-30 percent based on the total weight of the composition.

The present invention contains the latest synthetic technology that provides a coolant, corrosion inhibitor, and a lubricity cement additive all in one cement pump additive. The present invention provides the combination of cooling and rust protection with a low foaming additive package. This additive is formulated to protect and extend the life of pump components. The additive also has a high cleaning action but does not have any foaming issues. The recommended concentration of the solution is 1 part to 20 parts cement slurry.

The present invention mixes directly with the cement slurry in the cement pump of the ready mix truck or any other mixing vessel used for preparing cement slurry. The cementitious materials can comprise Portland cement, slags, fume silica, fly ash, colloidal silica and mixtures thereof. The cement aggregate can also contain particulate materials and solids used to control slurry density.

The present invention coats the liners and piston. First, it drops the temperature of the liners and piston, and second, it coats the components and adds a coating of lubricity to make the liners and pistons last longer. Since the cement in well bores are not designed to carry structural loads and is designed to seal the well casing pipe to the well bore, adding an additive does not hurt the integrity of the cement.

The pump additive is mixed directly with the cement slurry and does not require a separate priming-mixing step in order to use the additive. No additional equipment is necessary, no dumping site is necessary, and the pump additive does not adversely affect the composite strength of the cement. The present invention solves the prior art problems of priming additives waste issues, equipment issues, cost issues, time issues and wear on the equipment problems. The simplicity of use and method of mixing with cement slurry dramatically improves the previous methods.

When the cement mixing equipment blends the cement slurry, the pump additive is added directly to the mixing barrel containing the cement slurry. As the barrel turns, churns and mixes the cement slurry, the additive blends into the cement slurry. The additive solution may be checked by using an American Optical Refractometer before adding to the blended cement mixture. The refractometer multiplier is 4.0 to obtain the correct concentration.

As the cement slurry mixes with the pump additive in the pump barrel, the cement slurry blended comes into direct contact with the cement pump components. This contact allows the pump additive to lubricate all of the component parts in the mixing process. The conduit that delivers the cement slurry to the end use location also comes into direct contact with the cement slurry pump additive blend when the cement slurry mixture is pumped to its final destination. No priming step is necessary. The standard mixing activities used in preparing the concrete slurry, prepare and blend the pump additive mixture without any additional equipment, steps, or wasteful byproduct. This pump additive concrete slurry mixture contains lubrication that provides a corrosion inhibitor that protects the component parts from the harsh side effects of the aggregate rubbing against the liners, pistons and pump component parts.

The components of the pump additive also acts as a coolant. The cement slurry mixture coats the liners and piston. First, it drops the temperature of the liners and piston, and second, it coats the components and adds a coating of lubricity to make the liners and pistons last longer.

The following example is provided to illustrate the practice of the invention as well as certain preferred embodiments. The example provided should not be viewed as a limitation in any way. The spirit or scope of the invention is not limited to the following example in any way, shape, or form.

A cement service and supplier entity tested the present invention in their fleet of cementing trucks. The service entity was not using any cement additives geared towards protecting their pumps or component parts in their standard operations. The cement was mixed per standard protocol in their standard business operation. The cement was then blended with the addition of the novel cement pumping additive of the present invention.

Typically the testing entity needs to replace the component pump parts including liners or sleeves in their pump systems after around forty hours of pump time. By in large, forty hours of pump time occurs every two to four weeks during an average production schedule for the concrete entity. To replace the component parts of the pumping system including the liners, the concrete trucks are pulled from service and replacement parts are fitted onto the truck. This maintenance step includes several steps that cost the concrete entity a signification amount of time and replace costs for the parts themselves. The cost of replacing the liners in and of itself is a tremendously costly maintenance problem. Any improvement in liner lifespan would vastly improve the efficacy of the pumping system.

The testing entity used the cement pump additive in company owned ready mix trucks to evaluate the performance of our additive. They used fifteen gallons of the cement pump additive to each load of cement before pumping downhole to cement the casing into the wellbore. After four months of pumping cement through the test pump, they dismantled the pump for inspection and decided not to replace the liners. Upon inspection, the liner was still in serviceable condition so the technician put the existing component parts back on the equipment for additional use. They then continued to use the test pump, and continued to pump cement for almost two more months before the liners had to be replaced. This test resulted in the test pump component parts efficient working almost six months before the liners had to be replaced instead of every week to two weeks without the addition of the novel pump additive in the present invention.

After several months of testing the present invention, the service entity pulled the liners and component parts to evaluate their corrosion and overall general condition. On average, the liner or sleeve replacement intervals were extended to a minimum of three hundred percent extended liner life. On the most successful end, the life of the liners and sleeves were extended by almost seven hundred percent.

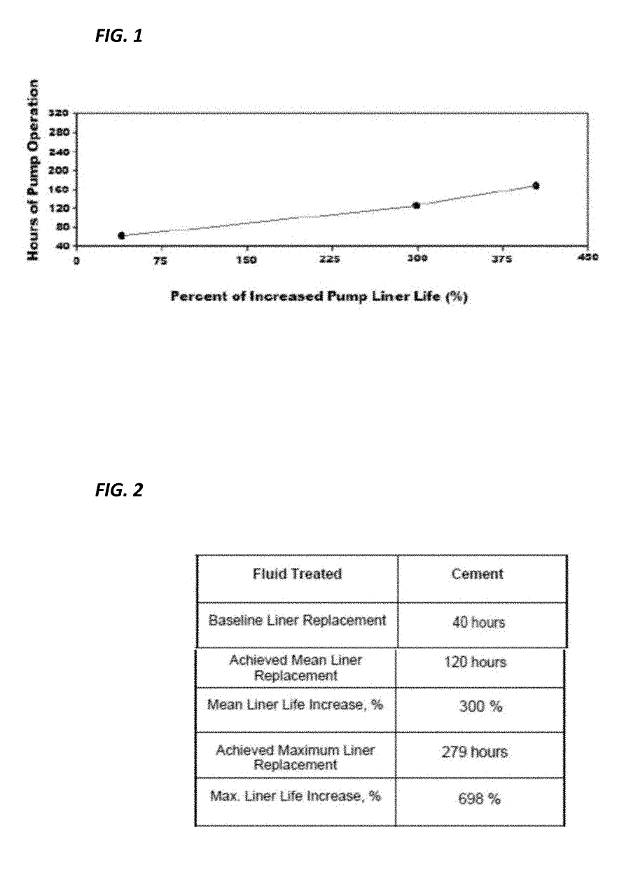

FIG. 1 demonstrates the percent of increase pump liner life based on the hours of pump operation the liners were useable prior to maintenance or required replacement. The hours of operation begins at forty, which is the average liner life without the present invention.

FIG. 2 charts the results of the months of testing of the present invention. The baseline liner replacement is on average required every forty hours. The cement slurry mixed with the present invention achieved a mean liner replacement of one hundred twenty hours. Obviously, this dramatic increase in the hours of extended liner life is a monumental improvement over the current liner lifer without the cement additive. The mean liner life increase was three hundred percent with the cement additive. The maximum liner life achieved was two hundred and seventy nine hours. This maximum liner life increase over the standard forty-hour life is six hundred ninety eight percent.

The resulting mixture of cement slurry blended with the novel pump additive exhibited superior lubrication and protection characteristics such as high impact resistant liner lifespan, a great degree of protection for continuous use of liner and component parts that greatly exceeds the average lifespan of the component parts without the novel additive, and superior increase in overall efficacy including substantial cost and time savings by utilizing the present invention in concrete pumping systems.

This present invention also works well when mixed and added to drilling mud, and will protect the liners in a large drilling mud pump as well. Additionally, the product will protect the liners in a pump used to pump fluids and proponents when fracking a well, too.

The foregoing detailed description and examples are given for clarity only. No unnecessary limitations are to be understood therefrom. The present invention is not limited to any specific details shown or described.

It should be noted and understood that various changes and modifications to the described preferred embodiments herein will be evident to those skilled in the art. Such changes and modifications can be made without deserting from the spirit and scope of the present invention and without weakening its intended advantages. It is therefore intended that such changes and modifications be enclosed by the appended claims.

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶6.

What is claimed is:

1. A method of lubricating the component parts of a concrete pump system comprising:
a. Providing a vessel or container holding a concrete composition;
b. Mixing the concrete composition with a liquid additive composition comprising monoethanolamine, triethanolamine, and Monbutyl ether;
c. Pumping the lubricating composition blend through the concrete pump system.

2. The method of claim 1, where the mixing occurs in the mixing barrel of a concrete truck.

3. The method of claim 1, where the composition of concrete composition is Portland cement.

4. The method of claim 1, wherein the said monoethanolamine comprises 1-10% total weight of the composition.

5. The method of claim 1, wherein the said triethanolamine comprises 1-10% total weight of the composition.

6. The method of claim 1, wherein the said Monbutyl ether comprises 1-30% total weight of the composition.

7. The method of claim 1, wherein the liquid additive composition is prepared as a mixture of a range of one to twenty parts concrete composition.

8. The method of claim 7, wherein the mixing occurs in the mixing barrel of a concrete truck.

9. The method of claim 1, wherein the liquid additive composition has a pH within a range of from pH 9.5 to pH 10.1.

10. The method of claim 1, wherein the concrete pump system comprises a range of from one hundred to three hundred feet of conduit.

11. The method of claim 1, wherein the liquid additive composition is biodegradable.

12. The method of claim 1, wherein the cement blend composition includes aggregate to increase the overall density of the composition.

13. A cement composition preparable by mixing components comprising:
a. a cement blend composition;
b. liquid additive composition comprising monoethanolamine, triethanolamine, and Monbutyl ether.

14. The composition of claim 13 further comprising said monoethanolamine comprises 1-10% total weight of the composition.

15. The composition of claim 13, wherein the said triethanolamine comprises 1-10% total weight of the composition.

16. The composition of claim 13, wherein the said Monbutyl ether comprises 1-30% total weight of the composition.

17. The composition of claim 13, wherein the liquid additive composition is biodegradable.

18. The composition of claim 13, wherein the liquid additive composition is prepared as a mixture of a range of one to twenty parts concrete composition.

19. The composition of claim 13, wherein the mixing occurs in the mixing barrel of a concrete truck.

20. The composition of claim 13, wherein the liquid additive composition has a pH within a range of from pH 9.5 to pH 10.1.

21. The composition of claim 13, wherein the cement blend composition includes aggregate to increase the density of the composition.

22. A liquid additive composition preparable by mixing components comprising monoethanolamine, triethanolamine, and Monbutyl ether.

23. The composition of claim 22, further comprising said monoethanolamine comprises 1-10% total weight of the composition.

24. The composition of claim 22, wherein the said triethanolamine comprises 1-10% total weight of the composition.

25. The composition of claim 22, wherein the said Monbutyl ether comprises 1-30% total weight of the composition.
